(19) United States
(12) Patent Application Publication
(10) Pub. No.: US 2006/0210729 A1
(43) Pub. Date: Sep. 21, 2006

(54) Ink-jet recording sheet

(75) Inventors: Yukako Taka, Tokyo (JP); Toshihiko Iwasaki, Tokyo (JP); Hideo Sugimoto, Hyogo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/370,820

(22) Filed: Mar. 8, 2006

(30) Foreign Application Priority Data
Mar. 18, 2005 (JP) JP2005-079264

(51) Int. Cl. B41M 5/00

(52) U.S. Cl. 428/32.1

(57) ABSTRACT

An ink-jet recording sheet containing a non water absorptive support having thereon at least three ink absorptive layers C, B and A in that order, each of the three layers comprises inorganic microparticles and a binder, wherein the ink absorptive layer A contains a dispersion of the inorganic microparticles dispersed in the presence of a water soluble multivalent metal compound; and an order of an amount of liquid transfer for the three ink absorptive layers is: the layer B<the layer C<the layer A, provided that the amount of liquid transfer is measured with a Bristow's method which is defined by J. TAPPI Paper Pulp Test Method No. 51-87 using a mixture of diethylene glycol/triethylene glycol monobutyl ether/water, having a weight ratio of 15:15:70, with a contact time of 0.04 seconds.

This application is based on Japanese Patent Application No. 2005-079264 filed on Mar. 18, 2005 in Japanese Patent Office, the entire content of which is hereby incorporated by reference.

### TECHNICAL FIELD

The present invention relates to an ink-jet recording sheet (hereinafter also simply referred to as a recording sheet) with minimal formation of bleeding, resulting in higher image density and higher ink absorbability.

### BACKGROUND

In recent years, in order to achieve conventional photographic quality employing ink-jet recording, recording sheets have been improved. Along with the recent achievement of higher image quality, characteristics, such as higher ink absorbability or more rapid drying properties, requirements for the recording sheets have increasingly been elevated.

In ink-jet recording to achieve image quality equal to that-of conventional photographs, water-soluble dyes are preferably employed as a colorant in terms of the beauty of image quality. However, due to high hydrophilicity of such water-soluble dyes, when water droplets are deposited onto recorded surfaces, or recorded sheets are stored at high humidity over an extended period of time after recording, problems occur in which dyes tend to bleed. Namely, waterfastness is a major problem.

Further, ink-jet recording sheets having a porous ink absorptive layer are capable of forming uniform images during ink-jet recording due to their high ink absorbability. On the other hand, problems occur in which a decrease in image density tends to occur in such a manner that minute particles, forming the porous layer, scatter light from the surface.

As a method to improve waterfastness, a method is commonly used in which dye fixing components, such as cationic ones, are incorporated in the porous layer to bond anionic dyes, resulting in high immobilization.

Listed as such cationic components are cationic polymers such as quaternary ammonium salt polymers, cationic surface active agents, and metal ions. For example, a method is described in which cationic polymers and water-soluble polyvalent metal salts are simultaneously employed (refer, for example, to Patent Document 1).

However, these methods have resulted in still insufficient waterfastness and have not minimized bleeding during standing. Further, no disclosure is made with regard to improvement of color forming properties of porous ink-jet recording sheets.

A case is disclosed in which silica particles, the surface of which is treated with aluminum, are employed in the uppermost layer (refer, for example, to Patent Document 2). However, the resulting effects are limited to pigment inks, and when a dye ink is employed, the image density has been insufficient. Further, a dispersion incorporating minute organic particles of a high zeta potential and water-soluble polyvalent metal compounds are employed (refer, for example to Patent Document 3), while no disclosure is made with regard to enhancement of color forming properties.

Further, description is made in which either zirconium compounds or aluminum compounds are incorporated so that their concentration is higher in the portion farther from the support (refer, for example, to Patent Document 4). However, by only employing the above, bleeding has not sufficiently been minimized and color forming properties have also not been sufficiently improved.

(Patent Document 1) Japanese Patent Publication for Public Inspection (hereinafter referred to as JP-A) No. 60-67190

(Patent Document 2) JP-A No. 2000-351267

(Patent Document 3) JP-A No. 2004-285308

(Patent Document 2) JP-A No. 2002-160442

### SUMMARY

An object of the present invention is to provide an ink-jet recording sheet with minimal formation of bleeding, resulting in higher image density and higher ink absorbability.

It is possible to achieve the above object of the present invention employing the following embodiments.

(1) An ink-jet recording sheet comprising a non water absorptive support having thereon at least three ink absorptive layers C, B and A in that order, each of the three layers comprises inorganic microparticles and a binder,

the ink absorptive layer A is placed at the farthest position from the support, the ink absorptive layer C is placed at the nearest position from the support, and the ink absorptive layer C is placed between the ink absorptive layer A and the ink absorptive layer C,

wherein the ink absorptive layer A comprises a dispersion of the inorganic microparticles dispersed in the presence of a water soluble multivalent metal compound; and

an order of an amount of liquid transfer for the three ink absorptive layers is:

the layer B<the layer C<the layer A,

provided that the amount of liquid transfer is measured with a Bristow's method which is defined by J. TAPPI Paper Pulp Test Method No. 51-87 using a mixture of diethylene glycol/triethylene glycol monobutyl ether/water, having a weight ratio of 15:15:70, with a contact time of 0.04 seconds.

(2) The ink-jet recording sheet of the above-described item 1, wherein the ink absorptive layer is placed at the outermost position of the ink absorptive layers, and a dry thickness of the ink absorptive layer A is 5 to 20% based on the total thickness of the ink absorptive layers.

(3) The ink-jet recording sheet of the above-described items 1 or 2, wherein a dry thickness of the ink absorptive layer B is 10 to 20% based on the total thickness of the ink absorptive layers.

(4) The ink-jet recording sheet of the above-described items 1 or 2, wherein an oxide conversion value of the water soluble multivalent metal compound is in the range of 10 to 50 weight % based on an oxide conversion value of the inorganic microparticles.

(5) The ink-jet recording sheet of any one of the above-described items 1 to 4, wherein a coating composition for making the ink absorptive layer. A has a turbidity of not more than 50 ppm.

(6) The ink-jet recording sheet of the above-described item 4, wherein the water soluble multivalent metal compound is an aluminum compound or a zirconium compound.

(7) The ink-jet recording sheet of any one of the above-described items 1 to 6, wherein the inorganic microparticles are silica prepared by a gas phase method.

It was possible to provide an ink-jet recording sheet with minimal formation of bleeding, resulting in higher image density and higher ink absorbability by the present invention.

### DESCRIPTION OF THE PREFERRED EMBODIMENTS

The present invention will now be detailed. The inventors of the present invention discovered the following. When the liquid transfer amount during a contact time of 0.04 second, determined by the Bristow's method, is controlled to be in such a manner as layer B (interlayer)<layer C<layer A (uppermost layer), printed ink tends to hardly penetrate into the interlayer and the ink remains within the uppermost layer. As a result, while the ink remains within the uppermost layer, dyes are adsorbed onto minute cationized inorganic particles to result in an increase in image density. The following was also discovered. Since layer A initially absorbs a large amount ink, it is preferable that the liquid transfer amount is large. Further, by employing layers in which layer C results in a larger liquid transfer amount than that of layer B, it is possible to adsorb dyes without lowering the absorbability, whereby it is possible to absorb ink solvents. On the other hand, since dyes are adsorbed in the uppermost layer and in layer C, it is possible to separate an ink solvent into dyes and solvents, it is thereby possible to enhance bleeding resistance under high humidity.

For example, when layer B (being the interlayer) results in a large liquid transfer amount, dyes are absorbed by layers B and C before they are adsorbed in layer A (being the uppermost layer), whereby color formation deteriorates. Further, when the liquid transfer amount of layer A is low, overflow may result. While, when layer C results in a low liquid transfer amount, it is not possible to separate dyes from the ink solvents, whereby bleeding may increase.

(Layer Arrangement)

It is preferable that the ink-jet recording sheet according to the present invention exhibits a layer arrangement so that each of the liquid coating compositions is applied onto a support in the order of layers A, B, and C from the uppermost surface. In cases in which at least four layers are provided, it is possible to arrange at least one additional layer under layer C.

Further, each ink absorptive layer incorporates minute inorganic particles and binders. Layer A is composed of a minute inorganic particle dispersion which is dispersed in the presence of water-soluble polyvalent metal compounds. The above dispersion is applied onto a support and subsequently dried to form a layer. The resulting coating is then employed as an ink-jet recording sheet.

(Bristow's Method)

The Bristow's method, as described in the present invention, is one which determines liquid absorption behavior of paper and paperboard within a short time. In more detail, determination is made in accordance with Liquid Absorption Test Method of Paper and Paperboard (the Bristow's method) of J. TAPPI Paper Pulp Test Method No. 51-87, and determined values are represented by an ink transfer amount (in ml/m²) within a contact time of 0.04 second. Further, in the above test method, employed is pure water (ion-exchanged water). However, in the present invention, determination is made employing a solution prepared by mixing diethylene glycol, triethylene glycol monobutyl ether, and water at a weight ratio of 15, 15, and 70, respectively.

One example of the specific determination method will now be described. A recording sheet is allowed to stand at 25° C. and 50 percent relative humidity for at least 12 hours. Thereafter, determination is made employing, for example, Bristow's Testing Machine Type II (pressure applying type) which is a liquid dynamic absorbability testing machine, produced by Kumagai Riki Kogyo Co., Ltd. A determination solution is prepared by mixing diethylene glycol, triethylene glycol monobutyl ether, and water at a weight ratio of 15, 15, and 70, respectively. In order to enhance determination accuracy, commercially available dyes are added. After the specified contact time, by measuring the area of a dyed portion on the recording sheet, it is possible to determine the ink transfer amount. Further, the liquid transfer amount of each layer is determined as follows. A recoding sheet is prepared in such a manner that the liquid coating composition of each layer is individually applied onto a support to result in a coating weight of solids of 15 g/m² and subsequently dried. It is then possible to determine the liquid transfer amount based on the Bristow's method, employing the single layer-coated recording sheet.

Methods to change the liquid transfer amount within 0.04 second, specified in the present invention, are not particularly limited, but it is possible to increase the transfer amount by increasing the ratio (F/B) of minute inorganic particles to binders, or by increasing the diameter of minute inorganic particles. Further, when minute inorganic particles are dispersed, cationic polymer resins (also referred to as cationic polymers) are employed in the dispersion, and it is possible to adjust the transfer amount by controlling the amount of the above cationic polymer resins. Still further, in view of water absorption amount, it is preferable that inorganic mordants such as water-soluble polyvalent metal compounds are employed instead of cationic polymers.

(Water-Soluble Polyvalent Metal Compounds)

Water-soluble polyvalent inorganic compounds, when incorporated in a liquid coating composition incorporating minute inorganic particles, generally tend to result in coagulation which tends to result in minute coating defects as well as in a decrease in glossiness. Consequently, in order to incorporate water-soluble polyvalent metal compounds into layer A according to the present invention, the following steps are required. Minute inorganic particles are previously dispersed in the presence of water-soluble polyvalent metal compounds, and the resulting dispersion is employed to form layer A.

Examples of water-soluble polyvalent metal compounds related to the present inventions include sulfates, chlorides, and acetates of Mg²⁺, Ca²⁺, Zn²⁺, Zr²⁺, Ni²⁺, and Al³⁺. Of these, compounds incorporating Zr²⁺ and Al³⁺ are particularly preferred.

Further, inorganic polymer compounds such as basic polyaluminum hydroxide or zirconyl acetate are included in preferable water-soluble polyvalent metal compounds.

Zirconium atom containing compounds usable in the present invention exclude zirconium oxide. Specific examples of zirconium atom containing compounds usable in the present invention include zirconium difluoride, zirconium trifluoride, zirconium tetrafluoride, hexafluorozirconates (for example, potassium salts), heptafluorozirconates (for example, sodium salts, potassium salts, and ammonium salts), octafluorozirconates (for example, lithium salts), zirconium fluoride oxide, zirconium dichloride, zirconium trichloride, zirconium tetrachloride, hexachlorozirconates (for example, sodium salts and potassium salts), acid zirconium chloride (for example, zirconyl chloride), zirconium dibromide, zirconium tribromide, zirconium tetrabromide, zirconium bromide oxide, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acidic zirconyl sulfate trihydride, potassium zirconyl sulfate, zirconium selenate, zirconium nitrate, zirconyl nitrate, zirconium phosphate, zirconyl carbonate, ammonium zirconyl carbonate, zirconium acetate, zirconyl acetate, ammonium zirconyl acetate, zirconyl lactate, zirconyl citrate, zirconyl stearate, zirconium phosphate, zirconyl phosphate, zirconium oxalate, zirconium isopropionate, zirconium butyrate, zirconium acetylacetate, acetylacetone zirconium butyrate, stearic acid zirconium butyrate, zirconium acetate, bis(acetylacetonato)dichlorozirconium, and tris(acetylacetonato)chlorozirconium.

In view of significantly exhibiting bleeding resistance after printing, which is targeted by the present invention, preferred are zirconyl carbonate, ammonium zirconyl carbonate, zirconyl acetate, zirconyl nitrate, acid zirconyl chloride, zirconyl lactate, and zirconyl citrate, and of these, particularly preferred are ammonium zirconyl carbonate, acid zirconyl chloride, and zirconyl acetate. Listed as specific trade names of the above compounds are SAKUSAN ZIRCONYL ZA, produced by Daiichi Kidorui Genso Kagaku Kogyo Co., Ltd. and SAN ENKA ZIRCONYL, also produced by the same.

Compounds containing zirconium atoms may be employed individually or in combination of at least two types. When at least two types are employed, an advantage is assumed to be that it is possible to retard bronzing (a phenomena of resulting in metallic gloss via enhancement of crystallization of dyes in the ink), which tends to result when compounds incorporating zirconium atoms are employed.

Specific examples of aluminum atom containing compounds usable in the present invention include aluminum fluoride, hexafluoroaluminic acid (for example, potassium salts), aluminum chloride, basic aluminum chloride (polyaluminum chloride), tetrachloroaluminates (for example, sodium salts), aluminum bromide, tetrabromoaluminates (for example, potassium salts), aluminum iodide, aluminates (for example, sodium salts, potassium salts, and calcium salts), aluminum chlorate, aluminum perchlorate, aluminum thiocyanate, aluminum sulfate, basic aluminum sulfate, aluminum potassium sulfate (alum), ammonium aluminum sulfate (ammonium alum), sodium aluminum sulfate, aluminum phosphate, aluminum nitrate, aluminum hydrogen phosphate, aluminum carbonate, aluminum silicate polysulfate, aluminum formate, aluminum acetate, aluminum lactate, aluminum oxalate, aluminum isopropionate, aluminum butyrate, ethylacetate aluminum diisopropionate, aluminum tris(acetylacetonate), aluminum tris(ethylacetacetate), and aluminum monoacetylacetonatebis(ethylacetacetonate).

Of aluminium containing compounds, preferred are aluminum chloride, basic aluminum chloride, aluminum sulfate, basic aluminum sulfate, and basic aluminum sulfate silicate.

Polyaluminum chloride compounds are those represented by the formula of [Al₂(OH)ₙCl₆₋ₙ]ₘ, [Al(OH)₃]ₙ.AlCl₃. An example includes polyaluminum chloride which stably incorporates, as an effective component, polynuclear condensation ions (exhibiting polymer property) such as Al₆(OH)₁₅]³⁺, [Al₈(OH)₂₀]⁴⁺, or [Al₁₃(OH)₃₄]⁵⁺ which is basic and has a high positive valence.

Examples of commercially available polyaluminum chloride include polyaluminum hydroxide (Paho), produced by Asada Chemical K.K., polyaluminum chloride (PAC), produced by Taki Chemical K.K., and PURACHEM WT, produced by K. K. Riken Green.

Further, polyaluminum sulfate compounds are those represented by the formula of [Al₂(OH)ₙ(SO₄)_{6-n/2}]ₘ (wherein 0<n<6). A commercially available product includes basic aluminum sulfate (AHS), produced by Asada Chemical K.K.

A commercially available polyaluminum sulfate silicate product includes PASS produced by Nippon Light Metal Co., Ltd.

In view of enhancement of image density, the addition amount of water-soluble polyvalent metal compounds in terms of their oxide conversion value is preferably 10-50 percent by weight with respect to the oxide conversion value of minute inorganic particles, but is more preferably 15-30 percent by weight. When the addition amount of the water-soluble polyvalent compounds is less than 10 percent by weight, there is the possibility of a decrease in image density due to weak cationic properties, while when it exceeds 50 percent by weight, dispersion stability and the stability of the liquid coating compositions may be degraded. Further, in view of stability of the liquid coating compositions, it is preferable that water-soluble polyvalent compounds are incorporated during dispersion.

(Minute Inorganic Particle Dispersion Dispersed in the Presence of Water-Soluble Polyvalent Metal Compound)

Minute inorganic particle dispersion dispersed in the presence of water-soluble polyvalent metal compounds, according to the present invention, will now be described.

Minute inorganic particle dispersion dispersed in the presence of water-soluble polyvalent metal compounds according to the present invention is practically prepared as follows. Minute gas phase method silica particles the surface of which is anionic are incorporated in water, and the resulting mixture is dispersed (being the primary dispersion). The resulting dispersion is incorporated in an aqueous solution containing water-soluble polyvalent compounds, followed by the addition of pH controlling agents, and the resulting mixture is dispersed (being the secondary dispersion), whereby the targeted dispersion is prepared. It is preferable that the aqueous solution containing water-soluble polyvalent metal compounds is added prior to the secondary dispersion.

Employed as a method to achieve the above primary dispersion may be those commonly known in the art. It is possible to prepare the primary dispersion in such a manner that minute gas phase method silica particles are suction-dispersed in a medium composed mainly of water, employing, for example, a jet stream inductor mixer, produced by Mitamura Riken Kogyo Co., Ltd. Subsequently, water-soluble polyvalent compounds and pH controlling agents are added to the resulting primary dispersion and the resulting mixture is dispersed so that particles become smaller, whereby it is possible to prepare a minute inorganic particle dispersion.

Employed as a method to achieve the above secondary dispersion may be various conventional homogenizers such as a high speed rotation homogenizer, a media stirring type homogenizer (such as a ball mill and a sand mill), an ultrasonic homogenizer, a colloid mill homogenizer, a roller mill homogenizer, or a high pressure homogenizer. In the present invention, in view of efficiently performing dispersion of minute particle in a coagulated state, preferably employed is the ultrasonic homogenizer or the high pressure homogenizer.

In the above ultrasonic homogenizer, dispersion is achieved in such a manner that by emitting ultrasonic waves of 20-25 kHz, energy is concentrated on the solid-liquid interface, whereby very efficient dispersion is achieved. Subsequently, it is particularly suitable for preparing a dispersion in a small amount. On the other hand, in the high pressure homogenizer, one or two homogenous valves, the gap of which is controllable via a screw or oil pressure, are provided at the exit of the high pressure pump provided with 3 or 5 pistons. The flow of liquid medium conveyed by the high pressure pump is narrowed and is thereby subjected to pressure, whereby at the moment of passing the homogenous valve, minute substances are crushed. Since the above system enables dispersion of liquid in a large amount, it is particularly preferable for cases in which dispersion in a large amount is prepared. Pressure applied to the homogeneous valve is commonly 5-100 MPa. Dispersion may be finished via one pass or a number of repeated passes.

It is preferable that the minute inorganic particle dispersion dispersed in the presence of water-soluble polyvalent metal compounds according to the present invention is stabilized in which the surface of the minute inorganic particles is completely modified to be cationic. Further, as noted above, preferred as minute inorganic particles are minute gas phase method silica particles. When the mixing ratio of the water-soluble polyvalent metal compounds to the minute gas phase method silica particles is within the above range, the anionic components of the minute gas phase silica particles are completely covered with cationic components. Subsequently, preferable results are obtained in which no coarse particles which are formed due to ionic bond formation between the minute gas phase silica particles and the water-soluble polyvalent metal compound are formed. Further, at a lower content of the water-soluble polyvalent metal compounds, when blended with hydrophilic binders during preparation of the liquid coating composition, gelling tends to result. On the other hand, at a higher content of the water-soluble polyvalent metal compounds, occasionally occur problems of standing stability of the liquid coating composition.

It is preferable that the minute inorganic particle dispersion dispersed in the presence of the water-soluble polyvalent metal compounds according to the present invention is prepared by changing the pH of the aforesaid primary. dispersion employing the pH controlling agents. Thereby, a minute silica particle dispersion, which has been subjected to homogenous cation modification, is prepared. Thereafter, during the preparation process of an ink absorptive layer liquid coating composition, a stable liquid coating composition exhibiting neither turbidity change nor viscosity change is to be prepared. Consequently, it is possible to prepare high glossiness recording materials which maintain coating quality resulting in no coating problems such as cracking during production, which is a target of the present invention. It is more preferable that the minute cationic particle dispersion is prepared by elevating the pH during dispersion, whereby it is possible to enhance the absorbability and fixability of the ink. The variation of the pH is preferably in the range of 0.20-1.0. When the pH is less than 0.20, it is difficult to achieve the effects of the present invention, while when it exceeds 1.0, gelling and coagulation occasionally occur.

Listed as acids of the pH controlling agents may, for example, be organic acids such as formic acid, acetic acid, glycolic acid, oxalic acid, propionic acid, malonic acid, succinic acid, adipic acid, maleic acid, malic acid, tartaric acid, citric acid, benzoic acid, isophthalic acid, terephthalic acid, glutaric acid, gluconic acid, lactic acid, aspartic acid, glutamic acid, pimelic acid, or suberic acid, as well as inorganic acids such as hydrochloric acid, nitric acid, boric acid, or phosphoric acid. Further, listed as alkalis may be sodium hydroxide, potassium hydroxide, calcium hydroxide, ammonia water, potassium carbonate, sodium carbonate, trisodium phosphate, and triethanolamine. However, the present invention is not limited thereto. It is necessary that the addition amount of each of these various acids or alkalis is determined taking into account the acidity of various acids or the alkalinity depending on dispersion progress and dispersion stability.

Of the above pH controlling agents, preferred are boron compounds. Boron compounds, as described herein, refer to boric acid and salts thereof. Listed as examples may be borax, boric acid, borates (for example, orthoborates such as InBO₃, ScBO₃, YBO₃, LaBO₃, Mg₃(BO₃)₂, or Co₃(BO₃)₂, diborates (for example, Mg₂B₂O₅ and Co₂B₂O₅), metaborates (for example, LiBO₂, Ca(BO₂)₂, NaBO₂, and KBO₂), tetraborates (for example, Na₂B₄O₇.10H₂O), or pentaborates (for example, KB₅O₈.4H₂O, Ca₂B₆O₁₁.7H₂O, and CsB₅O₅). Aqueous boron compound solutions may be employed singly or in combination of at least two types. Particularly preferred is a mixed solution of borax and boric acid. When each of these is dissolved in water, the resulting solution exhibits relatively low concentration. However, when both of these are simultaneously dissolved in water, it is possible to prepare an aqueous solution at a high concentration, whereby it is possible to concentrate a dispersion. Further, there is an advantage in that it is possible to relatively freely control pH by changing the mixing ratio of borax and boric acid.

(Minute Inorganic Particles of Each Ink Absorptive Later)

Further, in view of ink absorbability and layer strength, for the ink absorptive layer other than layer A, it is preferable that minute inorganic particles are dispersed employing cationic polymers having a quaternary ammonium salt group. Particularly preferred are homopolymers of monomers having a quaternary ammonium salt group or copolymers of other one or at least two monomers which are polymerizable. When employed, it is preferable that the addition is performed during secondary dispersion. Further, in view of ink absorbability, it is preferable that a minute inorganic particle dispersion in which cationic polymers are employed, together with water-soluble polyvalent metal compounds.

Listed as monomers having a quaternary ammonium salt group may be the compound examples described, for example, in paragraphs [0028] and [0029] of JP-A No. 11-301096. Monomers capable of undergoing copolymerization with the above quaternary ammonium salt group are compounds having an ethylenic unsaturated group. Listed as such examples may be the compounds examples described, for example, in paragraph [0031] of JP-A No. 11-301096.

Specifically, when cationic polymers having a quaternary ammonium salt group are copolymers, the ratio of cationic monomers is preferably at least 10 mol percent, is more preferably at least 20 mol percent, but is most preferably at least 30 mol percent.

Monomers having a quaternary ammonium salt group may be composed of one type or at least two types.

Listed as specific examples of the cationic polymers having a quaternary ammonium salt group preferably employed in the present invention may be the compounds described in paragraphs [0035]-[0038] of JP-A No. 11-301096.

It is possible to prepare minute inorganic particle dispersions by incorporating various additives. If desired, it is possible to appropriately employ, for example, various nonionic or cationic surface active agents, antifoaming agents, nonionic hydrophilic polymers (such as polyvinyl alcohol, polyvinylpyrrolidone, polyethylene oxide, polyacrylamide, various saccharides, gelatin, or PULLULAN), nonionic or cationic latex dispersion, water-compatible organic solvents (such as ethyl acetate, methanol, ethanol, isopropanol, n-propanol, or acetone), and inorganic salts.

Specifically, water-compatible organic solvents are preferred since when mixed with an aqueous solution incorporating minute gas phase method silica particles and water-soluble polyvalent metal compounds, and/or cationic polymers, formation of minute substances is retarded. Such water-compatible organic solvents are employed in a dispersion in an amount of preferably 0.1-20 percent by weight, but more preferably 0.5-10 percent by weight.

(Dried Layer Thickness of Layer A)

The dried layer thickness of layer A is preferably 5-20 percent with respect to the total dried layer thickness, and further, 5-15 percent is preferred since it is thereby possible to simultaneously achieve high image density and high ink absorbability. When the above thickness ratio exceeds 20 percent, there is the possibility of a decrease in image density, while when it is less than 5 percent, it is not possible to achieve the desired high image density.

The total dried layer thickness, as described herein, refers to the dried layer thickness of all the layers applied onto the support of an ink-jet recording sheet.

(Dried Layer Thickness of Layer B)

The dried layer thickness of layer B is preferably 10-20 percent with respect to the total dried layer thickness. In view of ink absorbability, 10-15 percent is preferred. When the ratio is less than 10 percent, it is not possible to achieve the function exhibited by a barrier layer, whereby dyes are not adsorbed onto layer A. Further, when exceeding 20 percent, there is the possibility of flooding due to a decrease in ink absorbability.

(Case of at Least 4 Layers)

From the aspect of the absorption amount, when at least four layers are provided, it is possible to further arrange another layer under layer C. In such a case, the total thickness of layers A, B, and C is 75-85 percent with respect to the total dried layer thickness. When the ratio is less than 75 percent, it is not possible to exhibit the targeted effects of the present invention. When a layer which results in a liquid transfer amount which is almost equal to that of layer C is provided under layer C, the resulting two layers are regarded as layer C.

Further, the dried layer thickness obtained by totaling the thickness of each ink layer is preferably 30-60 μm. When the thickness is less than 30 μm, absorbability is degraded, while when it exceeds 60 μm, problems such as cracking may occasionally result during production.

(Turbidity)

When a minute inorganic particle dispersion is applied to an ink-jet recording sheet, the final degree of dispersion largely affects color forming properties. Consequently, at present, it is not possible to guarantee quality, employing only conventionally used number average particle diameter determined by an electron microscope and a particle size measurement instrument. In order to enhance color forming properties, it is critical to determine coarse particles in the dispersion. As such a means, it was discovered that by employing turbidity evaluation, it enabled determination of the above. Naturally, it is preferable to employ both the number average particle diameter and turbidity for the evaluation of the degree of dispersion. To achieve desired glossiness, the number average particle diameter is preferably 3-300 nm.

The turbidity value of the minute inorganic particle dispersion employed in these ink-jet recording sheets is preferably at most 50 ppm. In the present layer configuration, the turbidity value of layer A is more preferably at most 50 ppm from the viewpoint of color forming properties. The lower limit is not particularly limited, but is preferably as low as possible. In practice, it is assumed that the preferable lower limit is 5 ppm. In order to decrease turbidity, it is possible to employ methods such as replacing dispersing agents such as cationic polymers, alternating dispersing methods, increasing the dispersion concentration, extending the dispersing time, and decreasing the pH during dispersion.

The turbidity value of the present invention is determined employing an integrating-sphere type turbidimeter in which the dispersion is placed in its 5 mm wide quartz cell. Listed as such a turbidimeter is TURBIDIMETER SEP-PT-706D (produced by Mitsubishi Chemical Co., Ltd.).

Further, listed as inorganic microparticles employed in the porous ink absorptive layer excluding the uppermost layer according to the present invention may, for example, be white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, vapor phase method silica, wet system silica, colloidal silica, alumina, colloidal alumina, pseudo-boehmite, aluminum hydroxide, lithopone, zeolite, and magnesium hydroxide. Of these, most preferred inorganic particles for the ink-jet recording sheet of the present invention are silica-microparticles prepared by a gas phase method.

“Minute gas phase method silica particles”, as described in the present invention, refer to ultra-minute silica particles which are synthesized employing a so-called dry system or a gas phase method, which is represented by a production method in which silicon tetrachloride in synthetic silica, which is a synthetic silicon compound incorporating silicon dioxide as a main component, undergoes hydrolysis at the high temperature of at least 1,000° C., employing a hydrogen and oxygen flame. Such minute gas phase method silica particles includes the AEROSIL series available from Nippon Aerosil Co., Ltd., and the REOSIL series available from Tokuyama Co. Minute silica particles synthesized by the gas phase-method are available the surface of which is modified with aluminum. In such a case, the content of aluminum in the minute gas phase method silica particles is preferably 0.05-5 percent in terms of weight ratio.

Any appropriated diameter of the above minute gas phase method silica particles are possible, in which the average particle diameter (being the primary particle diameter) is preferably at most 1 μm. When the diameter exceeds 1 μm, glossiness and color forming properties tend to be degraded, whereby the diameter is preferably at most 200 nm, but is more preferably at most 100 nm. The lower limit of the particle diameter is not particularly limited, but in view of production of minute inorganic particles, it is preferably at least about 3 nm, but is most preferably at least 5 nm.

The average particle diameter of the above minute gas phase method silica particles is determined as follows. The cross section and surface of an ink absorptive layer are observed employing an electron microscope, and the particle diameter of each of 100 randomly selected particles is determined. Subsequently, the simple average value (the number average) is calculated. The particle diameter of each particle is represented by the diameter of the circular particle which has the same projective area as that of the particle.

Further, in the present invention, in view of production of high quality prints employing ink-jet recording sheets, it is preferable to employ minute gas phase method silica of an average particle diameter of at most 60 nm, having an isolated silanol group at a ratio of 5.0-7.0.

In the recording sheet of the present invention, by employing, in the ink absorptive layer, minute gas phase method silica particles of an average particle diameter of at most 60 nm, having an isolated silanol group at a ratio of 5.0-7.0, it is possible to achieve a void volume ratio of at least 60-percent even under high temperature drying conditions such as at least 40° C. The isolated silanol group ratio is more preferably in the range of 5.5-7.0. As the isolated silanol group ratio increases, the mutual interaction between particles is enhanced, tending to result in a higher ratio. However, it is not preferable that the isolated silanol group ratio exceeds 7.0, since handling becomes difficult due to an excessive increase in viscosity. It is possible to control the isolated silanol group ratio by varying the moisture content of the following minute gas phase method silica particles.

It is preferable to control the above ratio of the isolated silanol group of the minute gas phase method silica particles employing a method in which water vapor is sprayed onto them.

Listed as methods in which water vapor is sprayed may be a method in which while conveying minute gas phase method silica particles, water vapor is continuously sprayed, as well as a method in which minute gas phase method silica particles are charged into an sealed batch and water vapor is sprayed while aerated. Further, a method is also preferred in which the moisture content of minute gas phase method silica particles is controlled by storing them over at least 3 days in an ambience of a humidity of 20-60 percent.

Further, it is possible to determine the ratio of the isolated silanol group, as described in the present invention, employing FT-IR in accordance with the following method.

Minute gas phase method silica particles are dried at 120° C. for 24 hours, and FT-IR of the dried minute gas phase method silica particles is determined. Subsequently, absorbance at 3,750 cm⁻¹ attributed to Si—OH and absorbance at 1,870 cm⁻¹ attributed to Si—O—Si are determined, and the value obtained employing the following formula is designated as the ratio of the isolated silanol group.
Ratio of the isolated silanol group (hereinafter also referred to as the IR ratio)=(absorbance at 3,750 cm⁻¹/absorbance at 1,870 cm⁻¹)

Polyvinyl alcohols and their derivatives can be used in the ink-jet recording sheet of the present invention.

Polyvinyl alcohols preferably employed in the present invention include, other than common polyvinyl alcohol prepared by hydrolyzing polyvinyl acetate, modified polyvinyl alcohols such as polyvinyl alcohol in which chain terminals have undergone cationic modification or anion-modified polyvinyl alcohol having an anionic group.

Preferably employed as polyvinyl alcohol prepared by hydrolyzing vinyl acetate are those having an average degree of polymerization of at least 300, but those having an average degree of polymerization of 1,000-5,000 are particularly preferably employed. Those having a saponification ratio of 70-100 percent are preferred, while those of 80-99.8 percent are particularly preferred.

Listed as a cation-modified polyvinyl alcohol is one having a primary, secondary, or tertiary amino group, or a quaternary amino group on the main or branched chain of the above polyvinyl alcohol, as described, for example, in JP-A No. 61-10483. This is prepared by saponifying a copolymer of ethylenic unsaturated monomers, having a cationic group, with vinyl acetate.

Listed as ethylenic unsaturated monomers having a cationic group are, for example, tri-methyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyltrimethylammonium chloride, and trimethyl-(3-methacrylamidopropyl)ammonium chloride.

The ratio of monomers having a cation-modified group of the cation-modified polyvinyl alcohol is commonly 0.1-10 mol percent with respect to vinyl acetate, but is preferably 0.2-5 mol percent.

Listed as anion-modified polyvinyl alcohols are, for example, polyvinyl alcohol having an anionic group, described in JP-A No. 1-206088, copolymers of vinyl alcohol with vinyl compounds having a water-solubilizing group, described in JP-A Nos. 61-237681 and 63-307979, and modified polyvinyl alcohol having a water-solubilizing group, described in JP-A No. 7-285265.

Further listed as nonion-modified polyvinyl alcohols are, for example, polyvinyl alcohol derivatives partially added with a polyalkylene oxide group, described in JP-A No. 7-9758, and block copolymers of polyvinyl alcohol with hydrophobic group-containing vinyl compounds, described in JP-A No. 8-25795.

It is possible to simultaneously use at least two polyvinyl alcohols which differ in degree of polymerization or type of modification. Specifically, in the case of the use of polyvinyl alcohol at a degree of polymerization of at least 2,000, it is preferable that polyvinyl alcohol at a degree of polymerization of at least 2,000 is initially added to minute inorganic particles in an amount of 0.05-10 percent by weight with respect to the minute organic particles, but preferably 0.1-5 percent by weight, and subsequently, the above polyvinyl alcohol is added, resulting in no marked increase in viscosity.

The ratio of the minute gas phase method silica particles to the hydrophilic binders of the ink absorptive layer is preferably 2-20 in terms of weight ratio. When the weight ratio is at least 2, a porous layer exhibiting a sufficient void ratio is prepared, whereby a sufficient void volume is easily obtained. Consequently, no state occurs in which voids are sealed by swelling of hydrophilic binders during printing, whereby it becomes a factor in which it is possible to maintain a high ink absorption rate. On the other hand, when the ratio is at most 20, cracking tends to not occur when the void layer is applied at a higher thickness. Therefore, the ratio of the minute gas phase method silica particles to the hydrophilic binders is more preferably 2.5-12, but is most preferably 3-10.

In the ink absorptive layer, the total amount of the voids (the void volume) is preferably at least 20 ml per 1 m² of the ink-jet recording sheet. By making the void volume to be 20 ml/m² or more, it is possible to achieve a high ink absorbing ability, and as a result, it is possible to obtain a high image quality and decreased drying property of the ink.

In the ink-jet recording sheet of the present invention, it is preferable that polyvinyl alcohol, or derivatives thereof, have been polymerized employing ionization radiation.

(Supports)

Suitably employed as usable supports in the present invention may be those which are known as conventional ink-jet recording sheets. They may be water absorptive supports, but non-water absorptive supports are preferred. When using absorptive supports, cockling occasionally results while a support absorbs water in the ink, whereby post-printing quality is degraded.

Listed as usable water absorptive supports in the present invention may, for example, be common paper, fabrics, and sheets or plates comprising wood. Employed as paper supports may be those prepared by using, as a main raw material, chemical pulp such as LBKP and NBKP, mechanical pulp such as GP, CGP, RMP, TMP, CTMP, VMP, or PGW, and wood pulp such as waste paper pulp including DIP. In addition, if desired, it is possible to suitably use synthetic pulp and various fibrous materials such as synthetic fibers or inorganic fibers. If desired, it is possible to incorporate, into the above paper supports, various conventional additives such as sizing agents, pigments, paper strength enhancing agents, fixing agents, optical brightening agents, wet paper strengthening agents, and cationizing agents. Paper supports are prepared using a mixture of fibrous materials such as wood pulp with various additives while employing any of the various paper making machines such as a Fourdrinier paper machine, a cylinder paper machine, or a twin wire paper machine. Further, if desired, size press treatments using starch or polyvinyl alcohol are conducted during the paper making stage or employing a paper making machine, and various coating treatments as well as calender finishing may be carried out.

Non-water absorptive supports preferably usable in the present invention include transparent and opaque supports. Listed as transparent supports are films comprising materials such as polyester based resins, diacetate based resins, triacetate based resins, acryl based resins, polycarbonate based resins, polyvinyl chloride based resins, polyimide based resins, cellophane, or celluloid. Of these, preferred are those which are resistant to radiation heat when used for an overhead projector (OHP), and polyethylene terephthalate is particularly preferred. The thickness of such transparent supports is preferably 50-200 μm. Preferred as opaque supports are, for example, resin coated paper (so-called RC paper) carrying a polyolefin resin covering layer incorporating pigments on at least one side of the base paper, and so-called white PET which is prepared by incorporating white pigments such as bariums sulfate into polyethylene terephthalate. To enhance adhesion between any of the various above supports and the ink absorptive layer, it is preferable to apply a corona discharge treatment or a subbing treatment to the supports prior to coating of the ink absorptive layer. Further, the ink-jet recording sheets of the present invention need not always be colorless, but may be colored.

In the present invention, it is particularly preferred to employ, as ink-jet recording sheets, paper supports prepared by laminating both sides of a paper substrate with polyethylene, since it is thereby possible to produce at low cost high quality images approaching conventional photographic quality.

Paper supports, which are laminated with polyethylene, will now be described.

Base paper employed for a paper support is produced employing wood pulp as a main raw material, and if desired, employing synthetic pulp such as polypropylene, or synthetic fiber such as nylon or polyester. As wood pulp, for example, any of LBKP, LBSP, NBKP, NBSP, LDP, NDP, LUKP, and NUKP may be employed. However, LBKP, NBSP, LBSP, NDP, and LDP, having shorter fibers, are preferably employed in a larger proportion. However, the content proportion of LBSP or LDP is preferably from 10 to 70 percent by weight. As the above pulp, chemical pulp (sulfate salt pulp and sulfite pulp) containing minimum impurities is preferably employed, and pulp, which has been subjected to a bleaching treatment to increase whiteness, is also beneficial. It is possible to appropriately incorporate, into the base paper, sizing agents such as higher fatty acids or alkylketene dimers, white pigments such as talc or titanium oxide, paper strength enhancing agents such as starch, polyacrylamide, or polyvinyl alcohol, optical brightening agents, moisture retaining agents such as polyethylene glycol, dispersing agents, and softening agents such as quaternary ammonium. The freeness of pulp used for paper making is preferably 200-500 ml under the CSF specification, while in fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 percent by weight or less. The basic weight of base paper is preferably 30-250 g, but is more preferably 50-200 g, while the thickness of the base paper is preferably 40-250 μm. Base paper may result in high smoothness employing calender finishing during or after paper making. The density of base paper is customarily 0.7-1.2 g/cm³ (JIS P 8118). Further, the stiffness is preferably 20-200 g under conditions specified in JIS P 8153. Surface sizing agents may be applied onto the surface of base paper. The pH of base paper, when determined by the hot water extraction method specified in JIS P 8113, is preferably 5-9. Polyethylene which is employed to cover either or both surfaces of base paper is comprised of mainly low density polyethylene (LDPE) and/or high density polyethylene (HDPE). However, it is possible to partly use LLDPE and polypropylene. Specifically, preferred is a polyethylene layer, on the ink absorptive layer side, of which opacity and whiteness are improved by incorporating rutile or anatase type titanium oxide into the polyethylene as widely applied to photographic print paper. The content of titanium oxide is commonly 3-20 percent by weight with respect to polyethylene, but is preferably 4-13 percent by weight. The polyethylene coated paper is commonly employed as a glossy paper. In the present invention, further, it is possible to use polyethylene coated matte or silk surfaced paper, which is prepared as follows. When polyethylene is coated onto the surface of base paper via melt extrusion, a matte or silk surface is formed on common photographic paper by employing so-called embossing treatments. In the above polyethylene coated paper, it is particularly preferable to maintain the moisture content of the paper in the range of 3-10 percent by weight.

During production of the ink-jet-recording sheets of the present invention, it is possible to apply, onto a support, the constituting layers such as an ink absorptive layer according to the present invention, employing an appropriate method selected from conventional methods. By employing the preferred method, a liquid coating composition, which constitutes each of the layers, is applied onto a support and subsequently dried. In this case, it is possible to simultaneously apply at least two layers onto a support. Examples of coating methods which are preferably employed include a roller coating method, a rod bar coating method, an air knife coating method, a spray coating method, a curtain coating method, or an extrusion coating method using a hopper, described in U.S. Pat. No. 2,681,294.

### EXAMPLES

(Cationic Silica Dispersion A)

To 50 g of a 20% aqueous Cationic Polymer (1) solution was added 500 g of a 20% aqueous minute gas phase method silica particle dispersion (AEROSIL 200, made by Japan Aerosil Co. Ltd.), and subsequently, 3 g of boric acid as well as 0.5 g of borax was also added. The resulting mixture was dispersed employing a homogenizer, whereby Cationic Silica Dispersion A was prepared.

(Cationic Silica Dispersion B)

Cationic Silica Dispersion B was prepared in the same manner as Cationic Silica Dispersion A, except that 50 g of the aqueous Cationic Polymer (1) solution was replaced with 90 g of polyaluminum chloride (TAKIBINE #1500, 23% in terms of Al₂O₃, produced by Taki Chemical K.K.).

(Cationic Silica Dispersion C)

Cationic Silica Dispersion C was prepared in the same manner as Cationic Silica Dispersion A, except that 20 g of the aqueous Cationic Polymer (1) solution was replaced with 25 g of the same and 1.6 g of polyaluminum chloride (TAKIBINE #1500, 23% in terms of Al₂O₃, produced by Taki Chemical K.K.) was added. 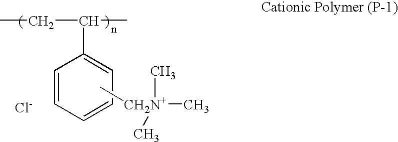
(Recording Sheet 1) Comparative Example

The following liquid coating compositions were subjected to simultaneous multi-layer coating in the order of the 2nd layer and the 1st layer to result in a respective dried layer thickness of 20 μm and the resulting coating was dried employing an air flow at 20-40° C., whereby Ink-jet Recording Sheet 1 was prepared.

1st Layer (Upper Layer) or (Layer B)

| | | |
|---|---|---|
| Cationic Silica Dispersion A (17%) | 500 | g |
| Polyvinyl alcohol (6%) (PVA235, produced by | 270 | ml |
| Kuraray Co., Ltd.) | | |
| Amphoteric surface active agent (6%) (FTERGENT | 2 | ml |
| 400S, produced by NEOS Co.) | | |

Lastly, the total volume was brought to 1,000 ml by the addition of pure water.

2nd Layer (Lower Layer) or (Layer C)

| | | |
|---|---|---|
| Cationic Silica Dispersion A (17%) | 500 | g |
| Polyvinyl alcohol (6%) (PVA235, produced by | 280 | ml |
| Kuraray Co., Ltd.) | | |
| Emulsion resin (55%) (SUMIKAFLEX 400HQ, | 10 | ml |
| produced by Sumitomo Chemical Co., Ltd.) | | |

Lastly, the total volume was brought to 1,000 ml by the addition of pure water.

(Recording Sheet 2) Comparative Example

The following liquid coating compositions were subjected to simultaneous multi-layer coating in the order of Layer C, Layer B, and Layer A to result in a respective dried layer thickness of 13 μm and the resulting coating was dried employing an air flow at 20-40° C., whereby Ink-jet Recording Sheet 2 was prepared.

Layer A (Uppermost Layer)

| | | |
|---|---|---|
| Cationic Silica Dispersion A (15%) | 690 | g |
| Polyvinyl alcohol (6%) (PVA235, produced by | 290 | ml |
| Kuraray Co., Ltd.) | | |
| Cationic surface active agent (6%) (COATAMINE | 2 | ml |
| 24P, produced by Kao Corp.) | | |
| Amphoteric surface active agent (6%) (FTERGENT | 2 | ml |
| 400S, produced by NEOS Co.) | | |

Lastly, the total volume was brought to 1,000 ml by the addition of pure water.

Layer B

The same as the Upper Layer of Recording Sheet 1

Layer C

The same as the Lower Layer of Recording Sheet 1

(Recording Sheet 3) Present Invention

Recording Sheet 3 was prepared in the same manner as Recording Sheet 2, except that Cationic Silica Dispersion A was replaced with Cationic Silica Dispersion C.

(Recording Sheet 4) Comparative Example

Recording Sheet 4 was prepared in the same manner as Recording Sheet 3, except that Layer A and Layer C were reversed.

(Recording Sheet 5) Present Invention

Recording Sheet 5 was prepared in the same manner as Recording Sheet 3, except that polyaluminum chloride of Cationic Silica Dispersion B in Layer A was replaced with ZIRCOSOL ZC-2 (produced by Daiichi Kigenso Kagaku Kogyo Co.) and the coated amount of ZrO₂ was the same as that of Al₂O₃.

(Recording Sheet 6)

Recording Sheet 6 was prepared in the same manner as Recording Sheet 3, except that the dried layer thickness of Layer A (being Uppermost Layer) was changed to 4 μm and the dried layer thickness of the other layers was changed to 18 μm.

(Recording Sheet 7)

Recording Sheet 7 was prepared in the same manner as Recording Sheet 6, except that the dried layer thickness of Layer B (being the layer contacting Layer A) was changed to 4 μm and the dried layer thickness of Layer C (being the layer contacting Layer B) was changed to 20 μm.

(Recording Sheet 8)

Recording Sheet 8 was prepared in the same manner as Recording Sheet 3,except that in the Layer A liquid coating composition, Cationic Silica Dispersion B was replaced with Cationic Silica Dispersion A, and the liquid coating composition which incorporated polyaluminum chloride (TAKIBINE #1500, produced by Taki Chemical K.K.) was employed to result in the same coated amount of Al₂O₃.

(Recording Sheet 9)

Recording Sheet 9 was prepared in the same manner as Recording Sheet 3, except that the weight of polyaluminum chloride of Cationic Silica Dispersion B of Layer A was changed to 17 g.

(Recording Sheet 10)

Recording Sheet 10 was prepared in the same manner as Recording Sheet 3, except that in Layer A, polyaluminum chloride was replaced with commercial magnesium chloride so that the MgCl₂ coated amount was the same as that of the Al₂O₃ coated amount.

(Recording Sheet 11)

Recording Sheet 11 was prepared in the same manner as Recording Sheet 3, except that in Layer A, the amount of polyaluminum chloride of Cationic Silica Dispersion B was changed to 217 g.

(Evaluation)

Color Forming Properties

Printed onto each recording sheet was a totally black image, employing a PM-G800 ink-jet printer and genuine dye ink, produced by Seiko Epson. Corp. The reflection density (visual) of the above solid black image was determined employing an optical reflection densitometer (X-RITE 938, produced by X-Rite Co.).
A: at least 2.1
B: from 2.0 to less than 2.1
C: from 1.9 to less than 2.0
D: less than 1.9
   Bleeding

At an ambience of 23° C. and 55% relative humidity, about 0.3 mm wide black lines were printed onto a solid blue background employing a PM-950C ink-jet printer and genuine ink, produced by Seiko Epson Corp. After natural drying for one hour, the resulting print was inserted into a transparent clear file folder, which was stored at 40° C. and 80% relative humidity for one week. Thereafter, the width of the black lines prior to and after storage was determined employing a microdensitometer (herein, the portion which exhibited 50% of the maximum density was designated as the line width). Bleeding was judged based on the following. A smaller value exhibits less bleeding and 130 or less results in no problems in practice.
Line width variation ratio=(black line width after storage)/(black line width prior to storage)×100
A: the line width variation ratio was at most 110
B: the line width variation ratio was more than 110 to at most 120
C: the line width variation ratio was more than 120 to at most 130 (resulting in no problems in practice)
D: the line width variation ratio exceeded more than 130 (resulting in problems in practice)
   Absorbability

At an ambience of 23° C. and 80% relative humidity, a varying blue density chart was printed employing EPSON PM950C, and the resulting print was visually judged.
A: neither non-uniformity nor overflow was noted
B: non-uniformity and overflow were slightly noted in the portions of a larger amount of ink.
C: non-uniformity and overflow were clearly noted in the portions of a larger amount of ink (resulting in problems in practice)
D: non-uniformity and overflow were clearly noted even in the portions of a less ink amount (resulting in problems in practice)
   Turbidity

The turbidity of a liquid coating composition placed in a 5 mm wide quartz cell was determined employing turbidimeter SEP-PT-706D (produced by Mitsubishi Chemical Co. Ltd.). Table 1 shows the results.

TABLE 1

| | | Liquid Transfer | | | Color | | | | |
|---|---|---|---|---|---|---|---|---|---|
| Recording | Layer | Amount (ml/m²) | | | Forming | | | | |
| Sheet | Configuration | Layer A | Layer B | Layer C | Properties | Bleeding | Absorbability | *1 | Remarks |
| 1 | 2 | 20 | 17 | — | D | C | C | 21 | Comp. |
| 2 | 3 | 23 | 20 | 17 | B | D | B | 16 | Comp. |
| 3 | 3 | 23 | 15 | 17 | B | A | B | 16 | Inv. |
| 4 | 3 | 17 | 15 | 23 | B | C | C | 21 | Comp. |
| 5 | 3 | 20 | 15 | 17 | B | B | B | 18 | Inv. |
| 6 | 3 | 23 | 15 | 17 | A | A | B | 16 | Inv. |
| 7 | 3 | 23 | 15 | 17 | A | A | A | 16 | Inv. |
| 8 | 3 | — not | 15 | 17 | not possible to prepare the | | | | Comp. |
| | | possible | | | composition due to excessive | | | | |
| | | | | | viscosity | | | | |
| 9 | 3 | 22 | 15 | 17 | B | B | B | 18 | Inv. |
| 10 | 3 | 19 | 15 | 17 | B | C | B | 20 | Inv. |
| 11 | 3 | 20 | 15 | 17 | C | B | B | 60 | Inv. |

*1: Turbidity of Liquid Coating Composition (A)
Comp.: Comparative Example,
Inv.: Present Invention

As can be seen from Table 1, ink-jet recording sheets of the present invention resulted in minimal bleeding, high image density, and desired ink absorbability.

What is claimed is:

1. An ink-jet recording sheet comprising a non water absorptive support having thereon at least three ink absorptive layers C, B and A in that order, each of the three layers comprises inorganic microparticles and a binder,
wherein the ink absorptive layer A comprises a dispersion of the inorganic microparticles dispersed in the presence of a water soluble multivalent metal compound; and
an order of an amount of liquid transfer for the three ink absorptive layers is:
the layer B<the layer C<the layer A,
provided that the amount of liquid transfer is measured with a Bristow's method which is defined by J. TAPPI Paper Pulp Test Method No. 51-87 using a mixture of diethylene glycol/triethylene glycol monobutyl ether/water, having a weight ratio of 15:15:70, with a contact time of 0.04 seconds.

2. The ink-jet recording sheet of claim 1, wherein the ink absorptive layer is placed at the outermost position of the ink absorptive layers, and a dry thickness of the ink absorptive layer A is 5 to 20% based on the total thickness of the ink absorptive layers.

3. The ink-jet recording sheet of claim 1, wherein a dry thickness of the ink absorptive layer B is 10 to 20% based on the total thickness of the ink absorptive layers.

4. The ink-jet recording sheet of claim 1, wherein an oxide conversion value of the water soluble multivalent metal compound is in the range of 10 to 50 weight % based on an oxide conversion value of the inorganic microparticles.

5. The ink-jet recording sheet of claim 1, wherein a coating composition for making the ink absorptive layer A has a turbidity of not more than 50 ppm.

6. The ink-jet recording sheet of claim 4, wherein the water soluble multivalent metal compound is an aluminum compound or a zirconium compound.

7. The ink-jet recording sheet of claim 1, wherein the inorganic microparticles are silica prepared by a gas phase method.
